(19) United States
(12) Patent Application Publication
(10) Pub. No.: US 2009/0042741 A1
(43) Pub. Date: Feb. 12, 2009

(54) MICROARRAY OF THREE-DIMENSIONAL HETEROPOLYMER MICROSTRUCTURES AND METHOD THEREFOR

(75) Inventors: Trent R. Northen, San Diego, CA (US); Neal W. Woodbury, Tempe, AZ (US)

Correspondence Address: QUARLES & BRADY LLP, RENAISSANCE ONE, TWO NORTH CENTRAL AVENUE, PHOENIX, AZ, 85004-2391, US

(73) Assignee: ARIZONA BOARD OF REGENTS, ACTING FOR AND ON BEHALF OF ARIZONA STATE UNIVERSITY, Tempe, AZ (US)

(21) Appl. No.: 10/599,770

(22) PCT Filed: May 6, 2005
(86) PCT No.: PCT/US2005/015764

§ 371 Date: Oct. 6, 2008

Related U.S. Application Data
(60) Provisional application No. 60/569,370, filed on May 6, 2004.
(60) Provisional application No. 60/608,774, filed on Sep. 10, 2004.
(60) Provisional application No. 60/623,181, filed on Oct. 29, 2004.

(51) Int. Cl. C40B 40/14; C40B 50/14

(52) U.S. Cl. 506/20; 506/30

(57) ABSTRACT

A microarray has a substrate and a plurality of three-dimensional microstructures formed on the substrate. Each of the three-dimensional microstructures is made with polymer material and has a plurality of reactive sites formed on its surface and interior pores. The polymer material is polymer gel or other porous polymer. The combination of three-dimensional microstructure and porous polymer material increases the surface area of the microstructure and density of the reactive sites on the surface of the microstructures. The higher density of reactive sites increases the luminescence, visibility or instrument detectability of the interaction between analytes and reactive microstructure sites on the microarray. A plurality of chemical groups are respectively attached to the reactive sites. The chemical groups each include at least one monomer. The chemical groups may have different chemical structures. A plurality of microchannels can be formed around the microstructures for isolation.

### CLAIM TO DOMESTIC PRIORITY

The present non-provisional patent application claims priority to provisional application Ser. No. 60/569,370, entitled “Light Directed Solid Phase Synthesis on Patterned Polymers”, filed on May 6, 2004, and further claims priority to provisional application Ser. No. 60/623,181, entitled “Peptide Characterized for Patterned Photopolymer Formed Using Light Directed Synthesis”, filed on Oct. 29, 2004, and further claims priority to provisional application Ser. No. 60/608,774, entitled “Light Activated Moving Polymers”, filed on Sep. 10, 2004.

### FIELD OF THE INVENTION

The present invention relates in general to arrays of chemically reactive structures and, more particularly, to a microarray of three-dimensional microstructures where the microstructures have a porous surface for providing a higher concentration of reactive sites for the patterned synthesis or attachment of functional molecular species such as heteropolymers.

### BACKGROUND OF THE INVENTION

Microarrays are commonly used in the analysis of an analyte, a mixture of analytes, or some unknown compound or substance, for the purposes of identification and quantification as well as to characterize physical and chemical properties. Microarrays can be used to determine the chemical composition, molecular structure, and properties of the analyte(s). For example, microarrays are often used to determine the presence of a specific compound or, in the case of DNA arrays, the microarray can be used to identify the presence or amount of specific gene transcripts or other specific nucleic acid sequences.

Microarrays are typically fabricated on a substrate which may consist, for example, of a silanized glass surface. Reactive chemicals or materials are disposed on the substrate in a monolayer at a number of different sites by some patterned chemical or physical process, such as photolithography. Microarray features are typically less than 10 mm, usually on order of 100 μm. Each monolayer element in the array has known reactive properties designed to bond or combine with a specific target chemical or molecular structure. Each reactive monolayer element can be selected or designed to interact with a specific target analyte. The interaction or reaction facilitates molecular recognition of the analyte. When exposed to various analytes, the reactive materials in the array elements bond or combine with the target analyte, which chemically modifies the microarray. The microarray can then be studied with analysis tools to see which element(s) reacted and thereby ascertain the composition or presence of the analyte(s).

In the prior art, microarrays are often constructed through sequential positioning of specific deprotections, and removing the protective groups from the reactive sites, followed by subsequent modification with chemical groups. Microarrays have used reactive sites with photolabile protective groups such as 6-nitroveratryloxycarbonyl (NVOC) to synthesize arrays of peptides on a glass substrate. In other microarrays, the reactive sites are protected with photolabile groups such as (alpha-methyl-o-nitropiperonyl)oxy]carbonyl) (MeNPOC) to synthesize DNA arrays on glass substrates. Still other microarrays are constructed by spotting materials of interest in specific positions on reactive silanized glass.

Another known characterization technique used in DNA arrays involves the hybridization of fluorescent probes and use of a scanning epifluorescent microscope or a sensitive camera system to detect such probes. A fluorescently labeled complimentary strand can be made for each array element making it possible to characterize any DNA microarray under the appropriate hybridization conditions.

In any case, the density of reactive sites on the monolayer surface of the microarray is very low, e.g. in the range of 10-30 picomoles/cm². The signals from such microarrays, which are typically fluorescent, are weak and require sensitive detection equipment. The low signal strength attributed to the low concentration of reactive sites on the monolayer surface of the microarray makes detection and analysis of the analyte difficult, and may require use of sophisticated and expensive equipment.

### SUMMARY OF THE INVENTION

In one embodiment, the present invention is an array of chemically reactive sites comprising a substrate and a plurality of three-dimensional microstructures formed on the substrate. Each three-dimensional microstructure is made with polymer material and has a plurality of reactive sites formed on a surface of the three-dimensional microstructure.

In another embodiment, the present invention is an array of chemically reactive sites comprising a substrate and a plurality of microstructures formed on the substrate. Each microstructure is made with porous polymer material and has a plurality of reactive sites formed on a surface of the microstructure.

In another embodiment, the present invention is a method of making an array of chemically reactive sites comprising providing a substrate, and disposing a plurality of three-dimensional microstructures on the substrate, each three-dimensional microstructure being made with polymer material and having plurality of reactive sites formed on a surface of the three-dimensional microstructure.

In another embodiment, the present invention is a plurality of polymer microstructures formed on a surface of an array of chemically reactive sites. Each microstructure comprises a plurality of reactive sites disposed on a plurality of surfaces of each polymer microstructure, and each reactive site has a reactant molecule with at least one monomer.

### BRIEF DESCRIPTION OF THE DRAWINGS

FIG. 1 illustrates a microarray of three-dimensional heteropolymer microstructures formed on a substrate;

FIG. 2 illustrates a microarray of heteropolymer microstructures formed on a substrate with an offset layout;

FIG. 3 illustrates a microarray of heteropolymer microstructures surrounded by other functional structures;

FIGS. 4a-4e illustrate embodiments for the three-dimensional microstructures with attached heteropolymers;

FIG. 5 illustrates a microarray with conical-shaped heteropolymer microstructures;

FIG. 6 illustrates a porous surface of the heteropolymer microstructure;

FIG. 7 illustrates another porous surface of the heteropolymer microstructure;

FIGS. 8a-8f illustrate a process of forming the heteropolymer microstructure with reactant molecules;

FIGS. 9a-9d illustrate the process of analyzing an analyte using the microarray;

FIG. 10 illustrates information from analysis of a microarray where the analysis tool is fluorescent imaging;

FIG. 11 illustrates information from analysis of a microarray where the analysis tool is mass spectrometry;

FIG. 12 illustrates information from analysis of a microarray where the analysis tool is mass spectrometry;

FIGS. 13a-13b illustrates movement of a polymer microstructure as a result of changes in swelling due to asymmetric changes in surface properties; and

FIG. 14 illustrates displacement of solvent from a polymer microstructure as seen by the movement of particles away from the polymer microstructure.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

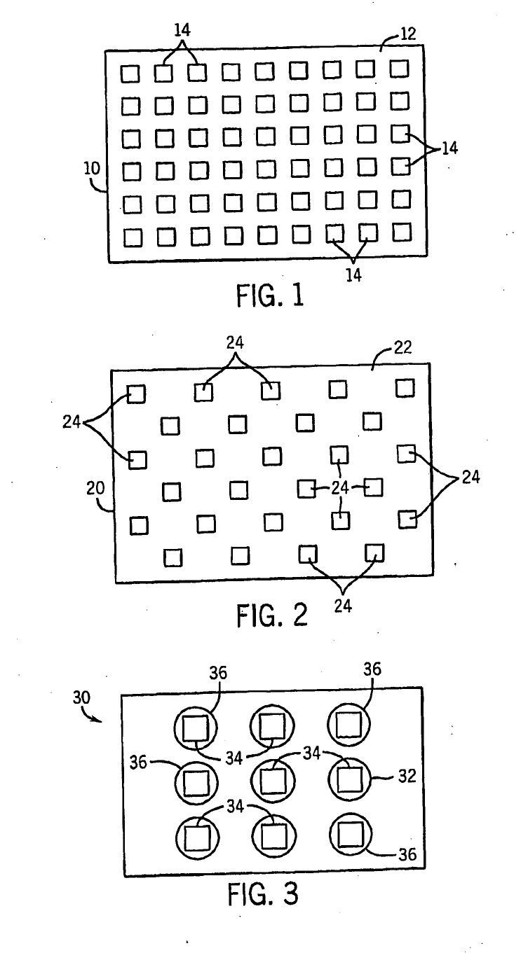

Referring to FIG. 1, a microarray 10 is shown suitable for use in molecular detection and analysis. The microarray is a small array of chemically reactive sites suitable for detection of analyte(s) in any commercial application. Microarray 10 has a substrate 12 made of silica, glass, plastic, semiconductor materials, conducting materials, insulating materials, arrays of semiconducting or conducting materials such as arrays of electrodes, arrays of functional structures such as electrodes, semiconductor electronic components, or microcantilevers, or other suitable physical structure support material. A plurality of polymer microstructures 14 are formed or disposed on substrate 12. Any two or more individual microstructures may or may not have identical composition. In one embodiment, microstructures 14 are made with polymer gel or porous polymer gel or porous polymer.

In FIG. 1, the microstructures 14 are formed in an N×M matrix or array of identical symmetrical rows and columns, where N and M are integers. Each microstructure 14 is a three-dimensional form having length, width, and height or depth, as discussed further below, and designed to have one or more reactive sites capable of bonding or combining with one or more predetermined chemical groups, or known or unknown analytes, i.e. each microstructure bonds with a specific chemical, a class of chemicals, or a specific molecular structure.

In general, each microstructure 14 can be selectively tailored to be chemically reactive with one or more specific chemical or molecular structures. The microstructures can be designed to selectively attach reactant molecules, such as peptides and fluorescent dye molecules, to the microstructures by using photolabile protective groups, or other protective groups whose chemistry is adaptable to patterned release (electrochemical processes, for example), as discussed below. Given the tailored reactive properties of each microstructure 14, the microarray reacts when exposed to an analyte. Upon exposure, the analyte may bond, combine, or otherwise interact with the reactive site(s), which are designed to react with the given analyte or mixture of analytes. The mixture of analytes can be used to determine which heteropolymer microstructure interacts with a given analyte, or to identify analytes in the mixture which interact in some way with the heteropolymer microstructures. With the analyte bonded to or having interacted with the associated reactive site, the microarray is then studied with various analytical tools, such as mass spectrometry or fluorescent imaging, to see which site(s) have reacted with the analyte and/or to determine the identity or properties of the analyte(s) and/or microstructure(s).

The reacted sites are sometimes visible with one or more colors or intensities of light. The site(s) that have reacted can be used to indicate the identity, composition, and/or properties of the analyte(s) or microarray, a combination of the two, or to determine how the analyte has interacted with the microarray. Microarray 10 can thus be used for molecular recognition to identify the analyte and its physical and chemical properties and characteristics, properties of the array, and other properties that can be determined from the interaction of the site(s) with the analyte(s).

Substrate 12 of microarray 10 can have side on side dimensions ranging from about 1 micrometers (μm) by 1 μm to 100 millimeters (mm) by 100 mm. In the embodiment of FIG. 1, microarray 10 is shown with an array of 9 by 6 polymer microstructures 14 each having dimensions of 5 mm long, 5 mm wide, and 150 nanometers (nm) high. The microarray can be inset from the edge of the substrate by about 25 mm or more. The spacing between microstructures is typically between about 10 nm and 10 mm. In general, the density of microstructures 14 can range up to one billion structures/cm², using patterning methods known in the art.

Turning to FIG. 2, a microarray 20 is shown with substrate 22 having similar dimensions as microarray 10. Microarray 20 is formed with a plurality of polymer microstructures 24 formed in offset rows and columns, i.e. checkerboard pattern. As discussed in FIG. 1, each microstructure 24 is a three-dimensional form having length, width, and height or depth, and designed to have one or more reactive sites capable of bonding or combining with one or more known or unknown analytes, i.e. each microstructure interacts with one or more chemical or molecular structures. Microarray 20 illustrates an alternate layout of the microstructures as compared to FIG. 1. In other embodiments, the microstructures can be formed and laid out on the substrate in any convenient pattern useful in the molecular recognition phase of the analysis.

A microarray 30 is shown in FIG. 3 with substrate 32 having similar dimensions as the substrate in microarray 10. Microarray 30 is formed with a plurality of polymer microstructures 34 disposed in an N×M matrix or array of identical symmetrical rows and columns. Again, each microstructure 34 is a three-dimensional form having length, width, and height or depth, and designed to have one or more reactive sites capable of bonding or combining with one or more known or unknown analytes, i.e. each microstructure interacts with a chemical or molecular structure. In this case, the polymer microstructures 34 are surrounded by circular functional structures 36 which have dimensions ranging from about 100 nm to 25 mm in internal diameter. The functional structures may have any structure that adds functionality to the microarray. For example, the functional structures may serve to contain the analyte in the vicinity of the microstructures for chemical interaction. The functional structures may also operate as microfluidic channels to deliver reagents or analytes.

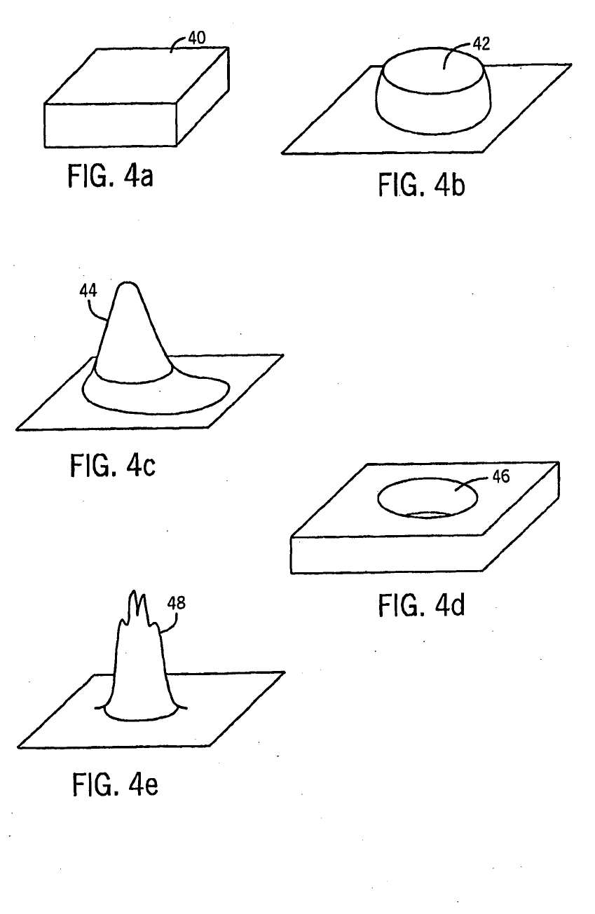

FIGS. 4a-4e illustrate several embodiments of the three-dimensional geometric form and shape of the microstructures as disposed on the substrate of the microarray. The geometric shape of the microstructure is made by design choice. In general, the microstructures are three-dimensional in form having length, width, and height or depth. The three-dimensional nature of the microstructures provides additional surface area upon which to form a higher concentration of reactant molecules as compared to prior art microarray reactive sites. The higher concentration of reactant molecules increases the visual or instrumentally detected indicators of reacted sites, i.e. those microstructures to which the incident analytes have bonded or interacted. The higher concentration of reactant molecules will cause these sites to be easier to identify, read, quantify and characterize, as compared to two-dimensional monolayer arrays. The higher concentration of reactant molecules enables and facilitates the use of many analytical methods to probe the array. In the case of optical approaches, they will emit a higher intensity of light in a fluorescent assay, result in greater signal in a Raleigh or Raman scattering measurement, and provide greater absorbance for an absorbance assay. In addition, there can be greater contrast between reacted sites and adjacent non-reacted sites or for reactant sites with a different composition. The analysis of the reacted microarray is easier to perform and may even be done with the naked eye in the case of changes in fluorescence, absorbency, or scattering in the visible region upon binding. The polymer microstructures may contain polymers or other materials which add additional properties, such as electrical conductivity, fluorescent properties, photoresponsive properties, thermally responsive properties, catalytic properties, magnetic properties, and ion conducting properties.

In FIG. 4a, a substantially rectangular solid or parallelepiped polymer microstructure 40 is shown with an x-dimension ranging from about 10 nm to 10 mm, y-dimension ranging from about 10 nm to 10 mm, and z-dimension ranging from about 1 nm to 10 mm. The microstructure 40 can be constructed by a variety of methods including molding or casting, thermal patterning, spotting or printing, utilization of surface forces, electromagnetic patterning, patterning using selective reactivity, using radiation, using ion or molecular beams, micromachining, etching, electrochemical deposition, electrochemical reaction, chemical deposition, various types of light directed patterning, such as photolithography, laser patterning, patterned projections from liquid crystal displays or micromirror arrays, and the like. In the case of thermal, electrochemical or light directed patterning to form the microstructure, an initiator or photoinitiator can be utilized. General classes of useful photoinitiators include azides (azobisisobutyronitrile and derivatives), ketones (benzophenone), thioxanthone, acridone aromatic diketones and derivatives, ketocoumarins and coumarins derivatives, dyes (e.g. xanthene dyes such as eosin (EO) or Rose Bengal (RB), thioxanthene dyes or cyanins), thioxanthones; bis-acylphosphine oxides, peresters, pyrylium and thiopyrylium salts in the presence of additives such as a perester, cationic dyes containing a borate anion, dyes/bis-imidazole derivatives/thiols, PS/chlorotriazine/additives, metallocene derivatives (such as titanocenes), dyes or ketones/metallocene derivatives/amines, cyanine dyes in the presence of additives, dyes/bis-imidazoles, miscellaneous systems such as phenoxazones, quinolinones, phthalocyanines, squaraines, squarylium containing azulenes, novel fluorone visible light PIs, benzopyranones, rhodamines, riboflavines, RB peroxybenzoate, PISs with good photosensitivity to the near IR, camphorquinone/peroxides, pyrromethane dye, crystal violet/benzofuranone derivatives, and two color sensitive systems. Colored cationic photoinitiators, such as iron arene salts, novel aromatic sulfonium or iodonium salts, and PS/cationic PI, where PS can be hydrocarbons or ketones or metal complexes, can help to shift the absorption in the visible wavelength range. Excited state processes of photosensitive systems for laser beams and/or conventional light sources can induce the polymerization reactions. Photosensitive systems under visible lights can include one-component systems such as bis-acylphosphine oxides, iron arene salts, peresters, organic borates, titanocenes, iminosulfonates, and oxime esters; two-component systems using through electron transfer and/or proton transfer, energy transfer, photoinduced bond cleavage via electron transfer reaction, and electron transfer; and three-component systems which enhance the photosensitivity by a combination of several components.

Polymer or monomer systems used to form the microstructures can include monomers which are polymerized or polymers that are crosslinked or both, such as acrylate, carbonate, methacrylate, propylene, ethylene, styrene, amide, ethers (acetal), halogenated monomers, urethane, epoxy, urea, amino acids, sugars, cellulose monomers, protein, glycols, lactic acid, ε-caprolactone, esters, nucleic acids (including DNA and RNA), peptides, trimethylene carbonate, N-vinylpyrrolidinone, and conducting polymers such as polypyrrole. The polymers/monomers can themselves contain pendent reactive groups like hydroxyl, epoxy, amino, carboxylate, vinyl, acrylate, methacrylate, or they can be incorporated after the polymerization reaction, for example amination of polyethylene.

Light sources for polymerization can include single or multiphoton excitation using lasers, semiconductor emitters (light emitting diodes, laser diodes) or lamps. The light may be modulated using shutters, masks, movable mirrors, acousto-optic devices, Kerr-cell devices, light emitting materials (conducting polymers, dyes, semiconductor materials), liquid crystal displays, micromirror arrays and optical gating devices such as nonlinear crystals. For example, polymer microstructure 40 can be made by immobilizing a high site density material within a photopolymer matrix. In this case, a porous polymer resin with high site density is prepared by combining 0.3 g 2-aminoethyl methacrylate, 1.95 g poly(ethylene glycol)dimethacrylate, 1.39 g trimethylolpropane ethoxylate (14/3 EO/OH) triacrylate, 50 mg azo-bis-isobutyronitrile, and 8 ml cyclohexanol. Nitrogen is bubbled through the solution for 10 minutes to remove oxygen and then the solution is heated to approximately 90° C. for approximately 20 minutes. After polymerization the polymer is ground in a mortar and pestle, washed with a pH 2 TFA water solution, water, methanol, dried, and dry sieved with a 75 micron (μm) sieve. About 20 milligrams (mg) of the above resin is swollen in 40 microliters (μL) methanol and suspended in a 1% 2,2′-azobisisobutyronitrile (AIBN) in trimethylolpropane trimethacrylate (TRIM) solution. Nitrogen is bubbled through the solution for 10 minutes to remove oxygen before loading it into a nitrogen purged flow cell with the functionalized glass slide and a 250 μm thick gasket separating the coverslip from the upper glass slide. The resin is polymerized using a micromirror array with a 380/50 nm bandpass filter for 5 minutes at an intensity of 54 mW/cm². The resultant shape is 250 μm cubes, which are rinsed with methanol and N,N′-dimethylformamide to remove unpolymerized monomer and the gasket is replaced with a 600 micron gasket to facilitate mixing. This example demonstrates the construction and formulation of polymer microstructures using a lamp and micromirror array where the microstructure is comprised of a polymer giving the microstructure shape and function and a high site density material which gives the polymer microstructures high densities of reactive sites.

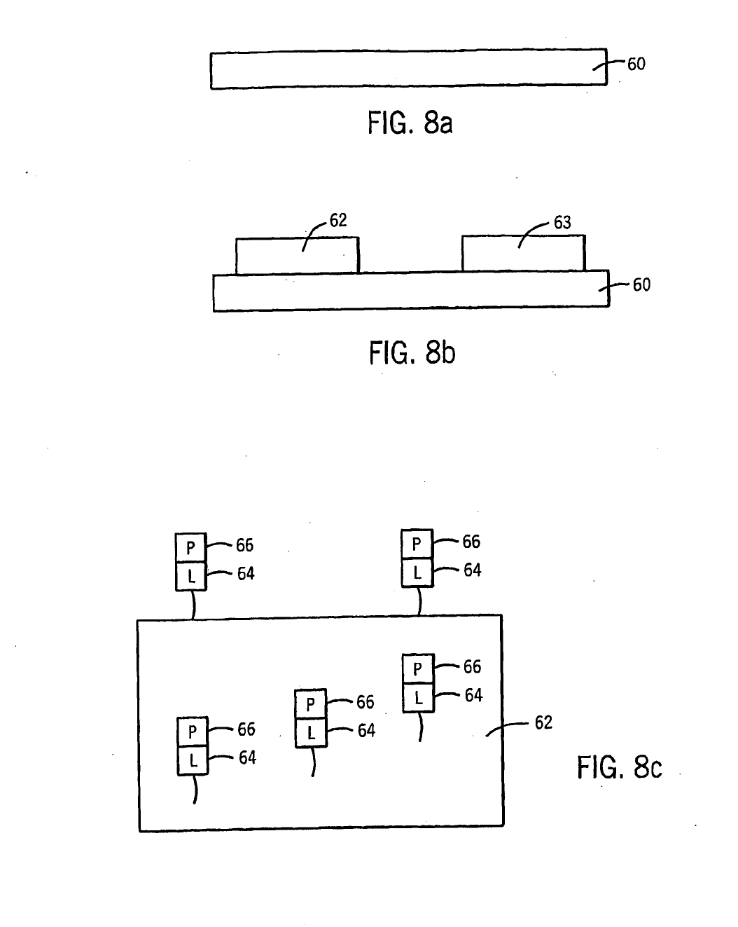

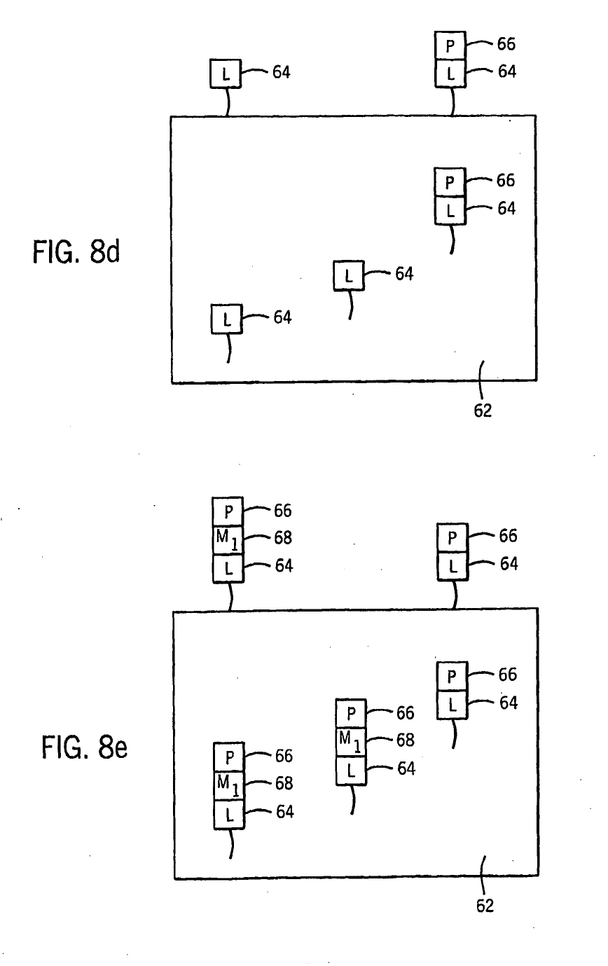

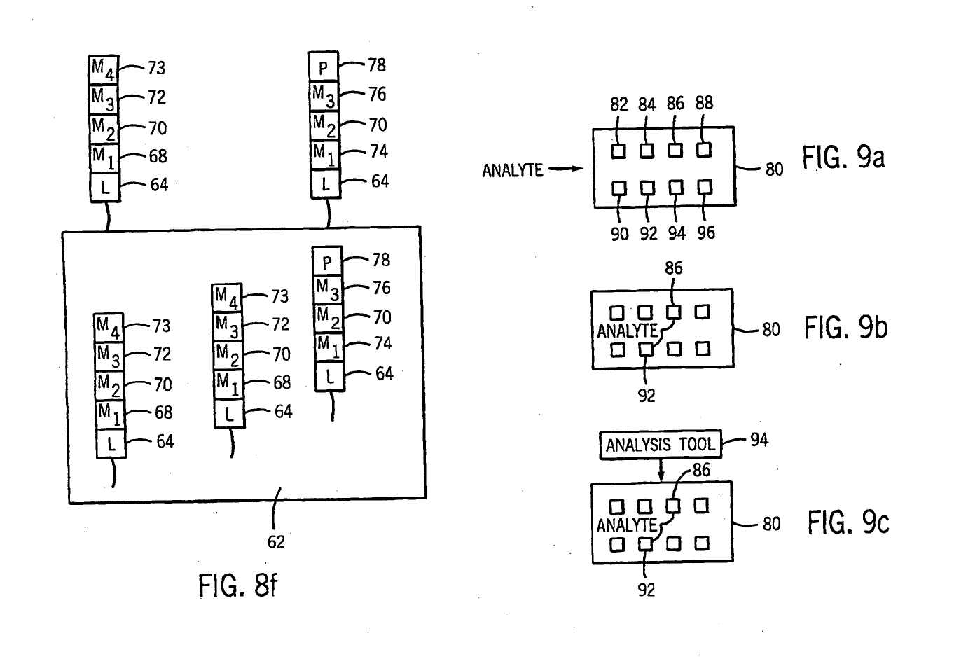

In FIG. 4b, a substantially cylindrical polymer microstructure 42 is shown with a diameter ranging from about 10 nm to 10 mm and z-dimension ranging from about 1 nm to 10 mm. In one embodiment, microstructure 42 can be constructed using similar methods as described in FIG. 4a, wherein the photopolymer gel structures are constructed directly from a material bearing reactive sites. Microstructures are prepared from a deoxygenated solution of 166 mg 2-amino ethyl methacrylate, 805 mg trimethylolpropane ethoxylate (14/3 EO/OH) triacrylate, 9.7 mg azo-bis-isobutyronitrile, 1188 mg cyclohexanol (note other solvents can be used to increase pore size for example mixtures of 1-dodecanol and cyclohexanol) in an optical cell with 250 μm gasket and 3-(trimethoxysilyl)propyl methacrylate functionalized glass slide as described in FIG. 8a. The polymerization is done with excitation from a micromirror array using a 380/50 excitation filter and exposing the features for 13 minutes. The structures are washed with methanol for more than 12 hours. One spot is tested with a 1% solution of 2,4,6-trinitorbenzenesulfonic acid (TNBS) in DMF which turns bright orange indicating the presence of primary amines. The resulting structure shows the direct construction of polymer microstructures from monomers one or more of which contains a reactive site that is incorporated into the polymer microstructures.

In FIG. 4c, a substantially conical polymer microstructure 44 is shown having base diameters ranging from about 10 nm to 10 mm and z-dimensions ranging from about 1 nm to 10 mm. The microstructure 44 can be constructed using similar methods as described in FIG. 4a. In one embodiment, a scanning laser system has been used to generate three-dimensional TRIM crosslinked poly(2-hydroxylethyl methacrylate) (HEMA) polymer microstructures through azo-bis-isobutyronitrile (AIBN) photopolymerizatioh using a 20× 0.5NA microscope objective and 365 nm laser excitation. A solution containing as solution of TRIM, HEMA, AIBN for example approximately 773 μl TRIM, 128 μL HEMA, 9 mg AIBN. The AIBN is prepared without removing oxygen and placed in the optical chamber, containing a silanized slide prepared as described in FIG. 8a, and irradiated at room temperature with 2-4 mW of 365 nm light for 1-2 seconds per feature. A 100× or 20× objective is typically used to focus the light on order of 100 μm above the surface of the cover slip to construct microarrays with features spaced on order of 500 μm apart. In general taller features are made with more laser power and/or longer exposures with the focus further about the surface. Excess monomer is drained and sample washed with methanol and DMF. These microstructures are later modified as described in FIG. 8c. Large pores are formed in regions of highest light flux. The resulting structure demonstrates the construction of polymer microstructures using a laser system where the microstructures made using a nonlinear process and are modified after polymerization to change their reactivity, which also demonstrates the three dimensional control of pores formation through the use of control of light intensity.

In FIG. 4d, a substantially cylindrical polymer microstructure 46 is formed in an inverted manner as a well or depression. The three-dimensional well-shaped microstructure 46 has a diameter ranging from about 10 nm to 10 mm, and z-dimension ranging from about 1 nm to 10 mm. The microstructure 46 can be constructed using similar methods as described in FIG. 4a. In one embodiment, the well-shaped microstructures can be made by placing several microliters of a monomer solution containing a free radical initiator in Teflon printed slides. The monomer is made from 10 microliters (μL) glycidyl methacrylate, 90 trimethylolpropane trimethacrylate solution containing 1% by AIBN. The 20 μL of the solution is placed in a 4 well Teflon printed slide, 5 mm well diameter, and placed in an oxygen free heated chamber at 85° C. for 1 hour. The structures can be later modified to modulate their reactivity, e.g. by reacting with a 10% solution of 1,4-Bis(3-aminopropoxy)butane in DMF for 15 minutes modifies the reactivity of the polymer microstructures and results in cylindrical microstructures with domed tops. The resulting structure demonstrates the use of surface forces to pattern polymer microstructures and post polymerization modification of the microstructures to change the reactive sites.

In FIG. 4e, an irregular-shaped polymer microstructure 48 has x-dimensions ranging from about 10 nm to 10 mm, y-dimensions ranging from about 10 nm to 10 mm, and z-dimensions ranging from 1 nm to 5 mm. The microstructure 48 can be constructed using similar methods as described in FIG. 4a.

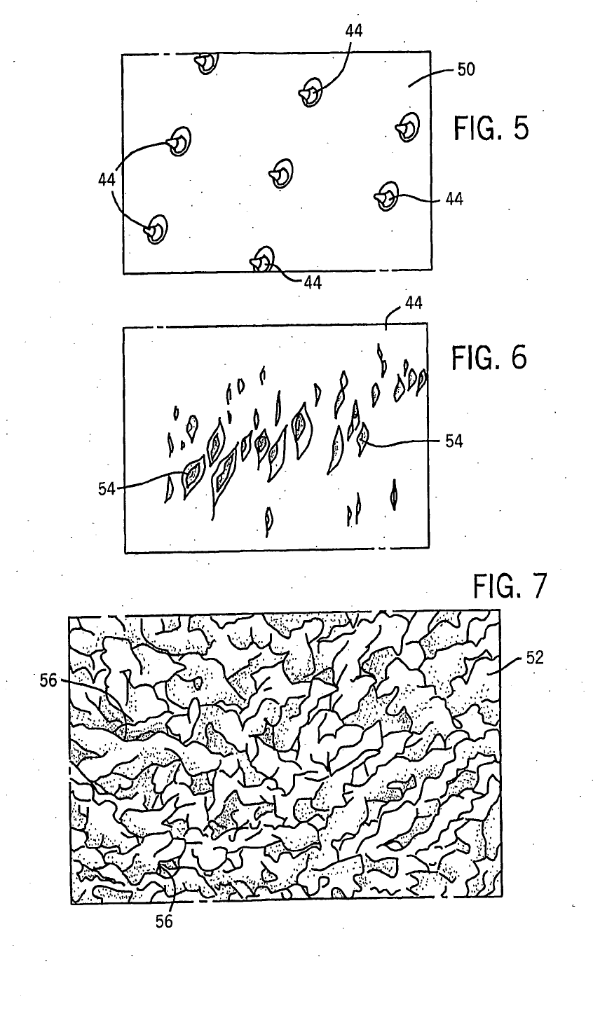

Turning to FIG. 5, a portion of an array of polymer microstructures is shown with conical microstructures like 44 from FIG. 4c formed on substrate 50. Arrays of microstructures can be made using any of the methods described in FIG. 4a-4e. The spacing between microstructures can be in the range of about 10 nm to 10 mm. Typical concentrations of reactive sites as determined using methods described in FIG. 8c are found to be on order of 0.1 nmole/feature for features on the order of 100 microns in all dimensions, providing an apparent surface density of on the order of 0.01 micromoles/cm² which represents a 10,000 fold enhancement over the prior art.

Notice that the microstructures are made three-dimensional in shape to achieve greater reactive surface area. The three-dimensional nature of the microstructures provides additional surface area upon which to form a higher concentration of reactant molecules. The higher concentration of reactant molecules per microarray reactive site makes it easier to determine the properties of the microarray and molecules bound to it and allows the use of analysis tools that are currently not commonly used for microarrays. For example, the higher concentration of reactant molecules will cause the reacted sites to emit higher intensity of light when interacted with a fluorescent material and can also have a greater contrast to adjacent non-reacted sites. Also, sites with such high concentrations of reactive groups allow the use of other analytical tools such as mass spectrometry.

Referring now to FIG. 6, a portion of polymer microstructure 44 is shown with porous regions 54 which are on order of a micrometer in feature size. The microstructure 44 can be made with polymer gels with porous structures such as regions 54 or rigid porous structures, or of nonporous polymers and polymer gels, which can be made by swelling in solvent, partial polymerization, partial cross-linking, phase separation, use of emulsions, trapping or formation of gas bubbles, polymerization of monomers containing a suspension of pore templates which are later dissolved, suspensions of porous materials, and post polymerization modification. The porous regions 54 may form without the use of porogens in regions of highest light flux due to phase separation during polymerization. The microstructures 44, like most polymer structures, will swell in a compatible solvent facilitating diffusion of reactants or analytes and increasing the available surface area versus the external surface area by several orders of magnitude.

In other words, the porous nature of the three-dimensional microstructures as shown in FIG. 6 further increases surface area upon which to form a higher concentration of reactant molecules. The higher concentration of reactant molecules per microarray reactive site increases the visual or instrumentally detected indicators of reacted sites. For example, the higher concentration of reactant molecules will cause the reacted sites to emit higher intensity of light when binding of an analyte results in fluorescence and with greater contrast to adjacent non-reacted sites.

Given the pores surrounded by polymer gel, the pores can greatly facilitate the diffusion of materials in and out of the polymer gel by acting as channels for reactants or analytes. In the case of microstructures like 40 as described in FIG. 4a, pores are obtained as a result of suspension of a porous solid phase synthesis material therefore allowing the independent optimization of photopolymer properties and solid phase synthesis properties.

In the case of microstructures 42 as described in FIG. 4b a porogen cyclohexane is used to form the porous structures as a result of phase separation during polymerization. Porogens can include any solvent, common ones include cyclohexane, methanol, 1-dodecanol, acetonitrile, ethylacetate, and polymeric porogens such as polystyrene particles. In the case of microstructures 44 as described in FIG. 4c, high light intensity is used to form pores without the use of a porogen and the largest pores are found to form in regions of highest intensity, which demonstrates the three dimensional control of pore formation in polymeric materials.

In FIG. 7, a portion of polymer microstructure 42 is shown with porous regions 56 on the surface and interior portions of the microstructure. The porous regions 56 are on order of one micrometer in feature size. Typically, these structures have concentrations of reactive sites as determined by methods described in FIG. 8c on order of 10 nmoles/feature for features with dimensions on the order of 100 microns, providing an apparent surface density of on the order of 1 micromoles/cm² which represents a million fold enhancement over the prior art. Large pores speed diffusion decreasing reaction times and solvent dependence of the polymer. A polymer gel, even without large pores, will swell in an organic solvent allowing the attachment of active groups however. The same polymer gel may not swell in a different solvent, such as water. If the analyte to be tested requires water as the primary solvent, the analyte may not be able to interact with the active groups restricting the interaction to the outer surface of the microstructure. By forming large pores or macropores, the solvent dependence of the microstructure is greatly reduced because the reagents and analyte can access the internal area of the polymer through the macropores. In the case of microstructures 44, a porogens cyclohexane or mixtures of cyclohexane and 1-dodecanol are used to form the porous structures as a result of phase separation during polymerization. Porogens can include any solvent, common ones include cyclohexane, methanol, 1-dodecanol, acetonitrile, ethylacetate, and polymeric porogens such as polystyrene particles.

Again, the porous nature of the three-dimensional microstructures as shown in FIG. 7 further increases surface area upon which to form a higher concentration of reactant molecules. The higher concentration of reactant molecules per microarray reactive site facilitates use and analysis, including visual and instrument detected indicators of reacted sites. The higher concentration of reactant molecules will cause the reacted sites to emit a higher intensity of fluorescence and/or with greater contrast to adjacent non-reacted sites, and facilitating the use of fluorescence detection or allowing the use of other analytical tools such as mass spectrometry.

There may be sufficient material on the polymer microstructures to allow the use of mass spectrometry to determine the molecular structure of materials bound or interacting with the polymer microstructure(s). Enabling the use of analytical tools such as mass spectrometry is significant because they can allow the determination of precise details of the molecular structure of materials on the array or interacting with the array, as compared to fluorescence or absorbance which in general gives little detailed information other then the presence or absence of a material.

The presence of the analyte bound to the reactive microstructure may change the chemical reactivity of the system. One instance would be a change in the electrochemical properties of the system allowing one to perform electrochemical assays of binding, particularly if the substrate consists of an array of electrodes.

In another example, the presence of the analyte might change the electrical conductance of the microstructure, which would be of particular interest if the microstructure is fabricated in such a way as to form a bridge between two electrodes on the substrate. The binding of analyte to the microstructure could change the total mass of the microstructure and therefore change the forces involved in accelerating the microstructure, which is particularly important in situations in which the microstructures are fabricated on microbalance devices such as oscillating cantilevers, where the change in mass results in a change in the characteristic frequency of the cantilever.

Alternatively, the binding of the analyte to the microstructure could change the total mass of the microstructure and therefore change the forces involved in accelerating the microstructure, which is particularly important in situations in which the microstructures are fabricated on microbalance devices such as oscillating cantilevers, where the change in mass results in a change in the characteristic frequency of the cantilever.

In yet another example, binding of the analyte to the microstructure could result in changes in the electrical properties of a semiconductor based electronic device (for example, a field effect transistor or a bipolar transistor or a diode) in a detectable fashion, which is of particular importance if the microstructures on fabricated directly on arrays of semiconductor devices or sensing elements.

In another example, the binding of the analyte to the microstructure could change the volume or solvation/hydration properties of the microstructure, which in turn could change the physical properties of the microstructure in a detectable way, for example, a change in index of refraction.

FIGS. 8a-8f illustrate the steps of making the microarray with microstructures and reactant molecules. The microarray uses spatially addressable synthesis. That is, microstructures like 62 and 63 in FIG. 8b, which in general can be located anywhere on the microarray, can be made with different polymer materials and exhibit different chemical properties. Likewise, the chemical groups formed on any specific microstructure can be different. For example, FIG. 8f illustrates microstructure 62 with two chemical groups having different chemical structures, i.e. L-M1-M2-M3-M4 and L-M1-M2-M3-P. Thus, each microstructure formed on substrate 60 can be selectively made of different polymer materials and the reactant molecules on each microstructure can be made to be chemically reactive with any of a broad range of analytes.

In FIG. 8a, a substrate 60 is made of silica, glass, or plastic, as described for 12 and has dimensions ranging from 100 mm to 1 μm in the x-dimension, 100 mm 1 μm in the y-dimension, and 1 mm to 50 μm in the z-dimension. In this case, the polymer microstructures will be covalently linked to the substrate. In the case of glass, many other oxides such as functionalized silanes provide a facile method for linking the polymer to the substrate. The glass surface will react with the silane to form a silicon oxygen bond, the other end of the silane can be selected so that it will react with the polymer or monomer therefore providing a covalent linkage between the polymer and the glass surface.

The silanization of the glass substrate is performed as follows. Glass cover slides are cleaned. The slides are immersed for 15 minutes at room temperature with 60/40 (v/v) sulfuric acid/hydrogen peroxide, 10% sodium hydroxide (w/v) at 70° C. for 3 minutes and 1% HCl at room temperature for 1 minute. Between steps, the slides are soaked in nanopure water for 3 minutes. A solution of 1-5% 3-(trimethoxysilyl)propyl methacrylate or aminopropyltriethoxysilane (APTES) in 95% ethanol/5% water is prepared and mixed for 10 minutes. The slides are immersed in the silane solution at room temperature for 15 minutes with gentle agitation. Slides are soaked in isopropyl alcohol for 3 minutes, nanopure water for 1 minute, and placed in a 100° C. oven for 5 minutes after which the oven is turned off and nitrogen is blown through for 1 hour. The slides are stored under nitrogen or argon.

In FIG. 8b, polymer microstructures 62 and 63 are attached to substrate 60. The microstructures 62-63 can be spaced as described in FIG. 2 and FIG. 3. The microstructures 62-63 can be covalently attached to an oxide surface such as glass using methods like that described in FIG. 8a. However, depending upon the application, it is not always necessary to have a covalent linkage between the microstructure and the substrate. Physisorption of the monomer or polymer onto the substrate surface can sufficiently immobilize of the polymer microstructures for some applications. The interactions may be enhanced by using a rough or etched or patterned surface thereby increase the area of contact and the strength of the immobilization and other functional properties.

in FIG. 8c, a portion of polymer microstructure 62 is shown. The internal and external surface of the polymer microstructure 62 is modified with a linker group L 64. The linker molecule can provide a great deal of functionality. Linking molecules are often used to change surface properties, e.g. polyethyleneglycol linkers are commonly used to prevent the nonspecific binding of proteins to surfaces. Linkers can also amplify the number of sites at the surface by coupling of dendrimeric materials such as PAMAM dendrimers or other multifunctional groups and can be used to introduce or increase the number of reactive sites or to modulate the surface properties of the polymer. Examples of other types of linking or surface modifying groups include, sugars, amino acids, nucleic acids such as DNA and RNA, peptides, proteins, polysaccharides, and other multifunctional amines or alcohols.

Linkers can also provide chemical functionality, i.e. the linker can be selectively cleaved allowing the removal of the group that is attached to the surface. Examples of labile linkers include acid labile linkers such the RINK amide linker, oxidatively labile hydrazinobenzoyl linker, base labile and/or linkers cleaved by nucleophiles such as 4-hydroxymethyl benzoic acid linkers, or photolabile linkers such as the hydroxyethyl photolinker, can be used to selectively remove materials from the polymer surface.

In peptide synthesis, orthogonal protective groups are used to modulate the various functional groups of the monomers and polymers. Side chain protective groups prevent the side chains from reacting during coupling steps. In general, the protective groups should not be labile under the conditions required during the removal of the protective groups used to control the growth of the polymer chain. In this case attached to the linker group is a protective group P 66. Protective groups include acid labile, base labile, reductively or oxidatively labile, thermally labile, electrochemically labile, and photolabile protective groups. Common groups include acid labile 4,4′-Dimethoxytrityl (DMT) or other tryityl derivatives, tert butyoxycarbonyl (BOC) and tert butyl (t-but) groups, base labile groups such 9-Fluorenylmethoxycarbonyl (FMOC), reductively labile groups such as the benzyloxycarbonyl group (cbz), and photolabile protecting agents such as aromatic nitro compounds such as nitroveratryloxycarbonyl (NVOC), 5′-((α-methyl-2-nitropiperonyloxy)carbonyl, (alpha-methyl-o-nitropiperonyl)oxy]carbonyl (MeNPoc), 2-(2-nitrophenyl)ethoxycarbonyl, 2-(2-nitrophenyl)ethylsulfonyl, and nitrophenylpropyloxycarbonyl. Other groups include 1-pyrenylmethyloxycarbonyl, alpha-Ketoester derivatives, Benzyl alcohol derivatives, Benzoin derivatives, Phenacyl esters, coumarin derivatives, hydroxyphenacyl, and benzyloxycarbonyl.

During chemical synthesis, it is often desirable to utilize a solvent that will swell microstructures to form polymer gels and solvate the growing polymer chain and/or reactants. Anhydrous solvents with the appropriate solvation properties are typically desirable given these considerations though water is often used for certain reactions such as attachment of DNA to reactive polymer microstructures. Common solvents include acetonitrile, N,N-Dimethylformamide (DMF), Dimethyl sulfoxide, 1-Methyl-2-pyrrolidone (NMP), and tetrahydrofuran(THF). In one embodiment, Fmoc-Rink or Fmoc-Gly is coupled to the hydroxyl group on the photopolymer microstructures prepared in FIG. 4c by reacting a solution of either using 33.7 mg Fmoc-Rink or 18.6 mg Fmoc-Gly, 22.5 mg HBTU, 11.5 μL DIPEA, and 600 μL DMF. The Fmoc-Rink or Fmoc-Gly, DIPEA, and DMF are combined and reacted for 3 minutes, and then added to the chamber and reacted with mixing at 50° C. for 30 minutes. The microstructures are rinsed with DMF and the Fmoc removed with 20% piperidine in DMF for 10 minutes. The yield of the reaction and number of reactive sites is determined by monitoring the absorbance at 301 nm of the Fmoc-piperidine adduct released.

In FIG. 8d, a portion of polymer microstructures 62, where internal and external surface of the polymer microstructure, is modified with a linker group L 64. A protective group P 66 is attached to the linker group. The protective group is selectively removed from the linkers in some positions using optical, electrical, thermal, or chemical means. The overall yield can be increased through the selection of appropriate deprotection conditions, such as temperature, pH, chemical content, solvent, light intensity, and electrochemical potential. In many cases, it is desirable to include scavengers when removing these protective groups to prevent reactive cleavage products from reacting with materials attached to the polymer microstructures. Examples of scavengers include triisopropyl silane can be used to scavenge cations resulting from the cleavage of t-but from a hydroxyl group using trifluoracetic acid (TFA) and semicarbazide HCl can be used to scavenge the aldehyde photocleavage product that results when nitroveratryloxycarbonyl is cleaved from an amino group.

In FIG. 8e is shown a portion of polymer microstructures 62 where internal and external surface of the polymer microstructure is modified with a linker group L 64. A protective group P 66 is attached to the linker group. The protective group has been selectively removed from the linkers is some positions using optical, electrical, thermal, or chemical processing and a monomer M1 68 has been attached bearing protective group P 66. Monomers can include amino acids, peptides, proteins, nucleotides, oligonucleotides, DNA, RNA, sugars, polysaccharides, polyethyleneglycols, lipids and derivatives, polymers, and/or other inorganic or organic molecules.

Consider the preparation of the polymer microstructures as described in FIG. 4a. A solution of 12 mg of the peptide FMOC-GGFL-COOH, 5.4 mg HBTU, 13 μL DIPEA, and 500 μL DMF is allowed to react for 3 minutes and then added to the microstructures. The microstructure is reacted for 1 hour at 50° C. and rinsed with DMF until the solution OD301 nm<0.2. After a 10 minute 20% piperidine in DMF rinse the solution OD301 is 0.97, the microstructure is rinsed with DMF and reacted with a solution containing 19 mg NVOC, 40 μL DIPEA, 600 μL DMF and reacted 1 hour in the dark at room temperature. The microstructure is-rinsed with DMF and a solution of 1% (w/w) semicarbazide HCl in methanol and allowed to soak in same solution for 10 minutes. One half of the array is illuminated for 5 minutes using the same apparatus used to make the microstructures. The microstructure is rinsed with methanol and DMF and a solution of 1 mg N-hydroxysuccinimide ester of N-Tris(2,4,6-trimethoxyphenyl)phosphonium acetic acid (TMPP-Ac-OSu-Br) 20 μL DIPEA, and 480 μL DMF is added and allowed to react at 35° C. for 30 minutes. The microstructure is then rinsed with DMF and methanol. The resulting structure demonstrates spatially addressable synthesis on the polymer microstructures described in FIG. 4a.

In FIG. 8f shows a portion of polymer microstructures 62 where internal and external surface of the polymer microstructure is modified with a linker group L 64. A protective group P 66 is attached to the linker group. The protective groups are selectively removed from the linkers in some positions using light, electrical, thermal, or chemical means to construct two types of polymers. One polymer contains monomers M1 68, M3 70, and M4 72. The second polymer contains monomers M2 74, M3 70, and M5 76.

Consider the preparation of the polymer microstructures as described in FIG. 4c, Fmoc synthesis is used to make Phe-Leu-Phe (FLF) on the polymer microstructures. The coupling steps are performed by reacting 63 μmoles of Fmoc-amino acid or peptide or Fmoc-Rink, 22.5 mg (59 μmoles, 0.94 eq) HBTU and 11.5 μL (66 μmoles, 1.5 eq) DIPEA in 600 μL DMF for 3 minutes, adding to the microstructures and reacting at 50° C. for 1 hour. The microstructure array is rinsed with DMF until the absorbance at 301 nm<0.1, and washed twice for 10 minutes with 20% piperidine in DMF, then washed with DMF to remove the piperidine. The absorbance at 301 nm is measured and compared to that of the Fmoc cleavage following addition of the linker as described in FIG. 8c to determine the stepwise yield.

NVOC-Phe is then coupled as described above with the exception that coupling is done at room temperature in the dark overnight. The surface is acylated by adding a solution of 29.2 μL DIPEA, 20 μL acetic anhydride, 1 μL DMF and allowing it to react for 1 hour at room temperature. The microstructure is rinsed in dioxane and left in dioxane. The same laser system used to make the structures is used to selectively remove the photolabile protective group from half of the features. Fmoc-leucine is coupled and the Fmoc group removed as described above. The resulting structure demonstrates spatially directed synthesis where two types of protective groups are used, one chemically labile and the other photolabile.

Accordingly, FIG. 8f illustrates a plurality of chemical groups respectively attached to reactive sites on the surface of the three-dimensional microstructure by the above process. One chemical group is L 64, M1 68, M2 70, M3 72 and M4 74. Another chemical group is L 64, M1 74, M2 70, M3 76, and P 78. As shown, each chemical group including at least one monomer Mᵢ. Note that the chemical groups have different chemical structures.

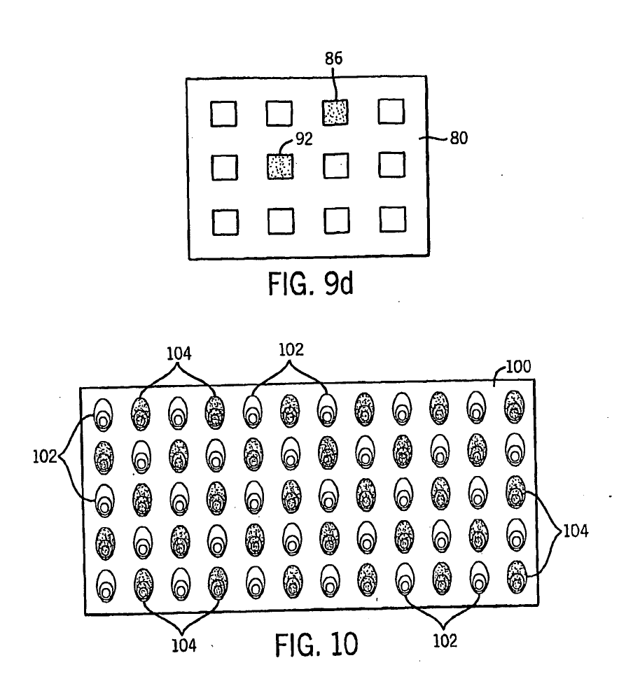

FIGS. 9a-9d illustrate the steps of exposing a microarray to an analyte, bonding the analyte to one or more reactive microstructure sites, and then analyzing the reacted microarray with analysis tools. The analysis tool provides identification and other information related to the analyte and/or microstructure.

In FIG. 9a, a portion of a polymer microarray is shown with microstructures 82, 84, 86, 88, 90, 92, 94, and 96 attached to substrate 80. The microstructures and substrate having dimensions, properties, order, preparation, and spacing as described in the preceding figures. The analyte can be introduced to the microstructures via a variety of methods including pressure driven flow, spotting of analyte, deposition of vapors or sprays, deposition of particles, exposure to gases, direct contact of the array with surfaces, and emersion of the array in test solution. Possible analytes of interest include biological materials, inorganic materials, and organic materials. Biological materials include proteins or peptides, DNA or RNA, sugars or polysaccharides, lipids, cells, organisms, and combinations thereof. Inorganic materials include metal ions, salts, inorganic complexes, and minerals. Organic materials include, drugs, dyes, toxins, pollutants, restricted substances and surfactants.

In FIG. 9b, the microarray from FIG. 9a is shown after treatment with analyte. In the present case, the analyte has interacted with the polymer microstructures 86 and 92. The interactions can include molecular recognition, chemical modification, enzymatic modification, cellular interactions, and catalytic properties. The molecular recognition feature involves binding of peptides to proteins or other materials of interest or binding of DNA to another nucleic acid such as RNA, peptides, proteins, and antibodies. The chemical modification feature involves oxidation or reduction of materials, changes in oxidation or reduction potentials, and chemical reactions. The enzymatic modification feature involves modification of proteins (phosphorylation, glycosylation, methylation, acetylation, proteolytic cleavage), electrochemical activity, proteolytic activity, nuclease activity, and other enzymatic reactions. The cellular interactions involve changes in biocompatibility, biofilm formation or inhibition, and changes in cell differentiation, cell-cell interactions, surface adhesion, cellular metabolism and proliferation. The catalytic properties include changes in electrochemical reaction rates, sterospecific reactions, polymer cleavage reactions, and synthetic organic catalytic properties.

In FIG. 9c, the microarray from FIG. 9b is shown undergoing evaluation by analysis tool 94. The analysis tool 94 is used to characterize the polymer microarray. The analysis tool reveals that polymer microstructures 86 and 92 have interacted with the analyte. Analysis tools include, UV-Visible-Infrared spectroscopy, Colorimetry, fluorescence spectroscopy, Raman spectroscopy, mass spectrometry, optical microscopy, circular dichorism, Fourier Transform Infrared Spectroscopy, ellipsometry, scanning probe microscopy, cantilever resonance, surface plasmon resonance spectroscopy electrochemical detection, electronic detection and high vacuum techniques including x-ray photoelectron spectroscopy.

In FIG. 9d, the polymer microarray in FIG. 9b as revealed by the analysis tool in FIG. 9c. The analysis tool revealed that polymer microstructures 86 and 92 have interacted with the analyte due to a change in their spectroscopic properties. In a colorometric test, the interaction may indicate some enzymatic or chemical activity. In another example, the presence of a fluorescent group demonstrates an interaction with structures 86 and 92 and not with the other microstructures. The microarray format provides an easy method for detecting and comparing changes in many of the microstructures at once.

In FIG. 10, the microarray is shown through the analysis tool 94 as described in FIG. 9d. In this case, the analysis tool 94 is a fluorescent imaging system. The analysis tool 94 reveals polymer microstructures 102 interacting with the analyte to show green fluorescence. Other polymer microstructures 104 have interacted with the analyte to show red fluorescence. The fluorescent groups could be any groups that can be differentiated on the basis of fluorescent properties such as the fluorescence spectrum, anisotropy or lifetime, e.g. the indicator groups could be fluorescently labeled DNA or RNA that have hybridized to the complimentary DNA or RNA on the microstructures or fluorescently labeled antibodies which are binding specifically to structures 102 and 104 due to molecular recognition. The polymer microstructures are prepared as described in FIG. 4c, Fmoc-Glycine is attached and then deprotected as described in FIG. 8c, the NVOC is attached to the microstructures and selectively removed as described in FIG. 8e with the exception that 60 mM semicarbazide with 3% DIPEA in DMF is used as the scavenging solution, the array is washed and treated with 4 mg Fluorescein isothiocyanate (FITC) in 600 μL DMF at 50° C. for 30 min. The array is washed and the above process is repeated to selectively remove NVOC, the array is washed and treated with 1 mg/mL Texas Red Sulfonyl Chloride (TR-SC) in DMF for 2 hours at room temperature and rinsed with DMF. The analysis tool 94 is an apparatus consisting of a Hg lamp to excite the dyes, a CCD camera to take images, and optical filters to provide the correct excitation and emission light. For FITC a 480/20 filter is used for excitation and a 540/25 filter is used for emission. For TR-SC a 560/40 filter is used for excitation and a 630/60 is used for emission. The two images are superimposed. The FITC (green fluorescence) is in the areas patterned first and the TR-SC (red fluorescence) is in the areas patterned second. In this case, the fluorescence is easily be seen by eye. The fluorescence from the polymer microstructures reveal an increase in fluorescence signal from the polymer microstructures on the order of 10,000-fold over the monolayers. The resulting structure demonstrates the selective attachment of fluorescent dyes and fluorescent detection as an analysis tool. The resulting structure further demonstrates spatially addressable synthesis on the polymer microstructures and the application of an analytical tool to determine the properties of the resulting microstructures.

As a second example involving the microstructures described in FIG. 4b, the polymer microstructures are treated with a solution of 102.5 mg N,N′-Disuccinimidyl carbonate, 66.1 μL DIPEA, and 8 mL acetonitrile for 4 hours. Single stranded DNA at 560 micromolar concentration in tris-HCl buffer pH 8 and 100 mM NaCl containing a 5′ amino group is spotted at 1-10 μL onto half of the features and the same procedure is used to spot a second sequence of DNA containing a 5′ amino group and allowed to react overnight. These two sequences are selected so that they will have specific interactions with their fluorescently labeled complimentary DNA probes and not with the noncomplimentary probe. The spots are passivated using a 150 micromolar solution of 1,4-Bis(3-aminopropoxy)butane in water for a few hours, and washed in buffer. The complimentary strands bearing green (FITC) and red fluorescent (Texas RedX) groups are hybridized and the array is washed and imaged as described in the previous example or simply using a lamp an inexpensive consumer digital camera with the same filters. Again the fluorescence is clearly visible by eye. The images of fluorescent structures with the appropriately positioned red fluorescent and green fluorescent DNA are obtained, which demonstrates the construction and use of polymer microarrays where the analyte interacts through molecular recognition with the array and is detected by fluorescence.

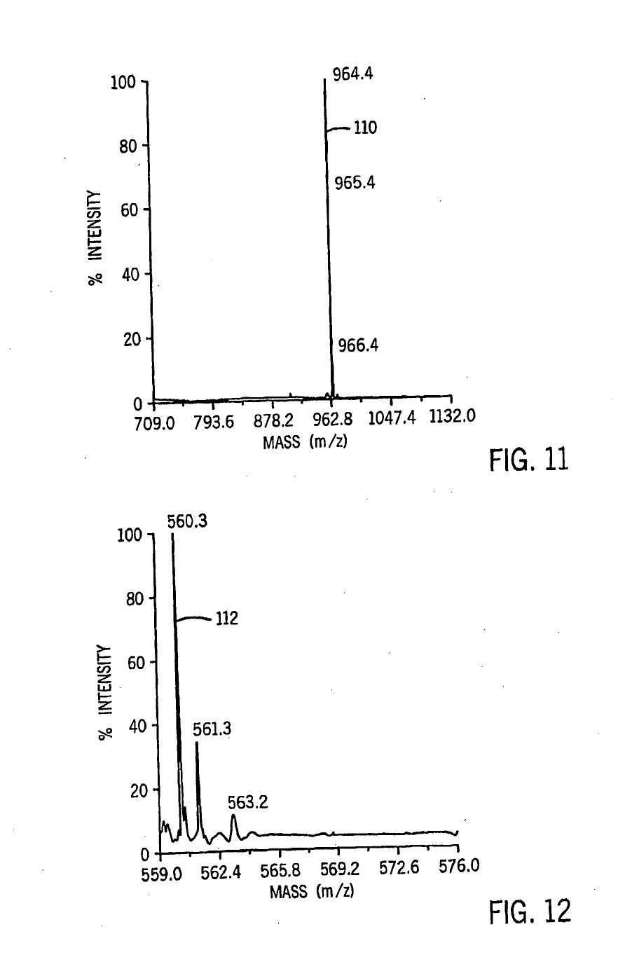

In FIG. 11, a microarray is revealed by the analytical tool described in FIG. 9d, wherein the tool is a mass spectrometer indicating that the mass 110 is 964.4 Da. The microarray is prepared as described in FIG. 8e and the analysis tool is Matrix Assisted Laser Desorption Ionization Mass Spectrometry MALDI-MS. The features are photopatterned and treated with the TMPP group, and then treated with a trifluoroacetic acid (TFA) solution. The solution is combined with the mass spectrometry matrices 4-hydroxybenzylidenemalononitrile (4-OH BMN) or α-cyano-4-hydroxycinnamic acid which are dissolved in 50% acetonitrile, 0.1% TFA, and nanopure water. The solution is assayed using the MALDI-MS. The resulting spectrum shows the product TMPP-GGFL-amide mass at 964.4 Da vs. 964.4 Da theoretical mass, the three major isotopes (964.4, 965.4, and 966.4) are also clearly visible and match the correct theoretical isotopic distribution expected from the photopatterned microstructures. These are not found in the unexposed miocrostructures, which demonstrates the synthesis of a modified peptide array using light and attachment of a peptide to the polymer microstructures.

In FIG. 12, a microarray is revealed by the analytical tool described in FIG. 9d, wherein the tool is a mass spectrometer indicating that the mass 112 is 560.3 Da. The microarray is prepared as described in FIG. 8f and the analysis tool is Matrix Assisted Laser Desorption Ionization Mass Spectrometry MALDI-MS. MALDI-MS is preformed as described in FIG. 11 resulting the detection of the LFFL-amide Na+ ion (560.3 Da vs 560.3 Da theoretical mass) in the arras that had been selectively patterned using light, which demonstrates the successful synthesis of a peptide microarray using multiple protective groups including chemical and photolabile groups and use of mass spectrometry as an analysis tool. The product is not found from microstructures in the areas not exposed to light, which demonstrates the chemically directed synthesis of a peptide on polymer microstructures and the use of mass spectrometry as an analysis tool.

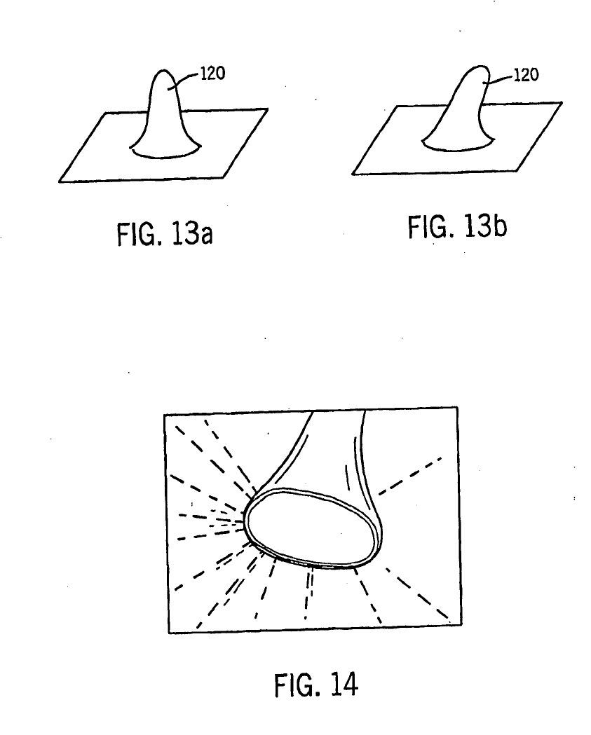

In FIGS. 13a-13b, is illustrated the movement of a polymer microstructure 120 as a result of changes in swelling due to asymmetric changes in surface properties. Light induces photochemical changes in the surface chemistry of porous polymer microstructures giving rise to a substantial change in volume. When illumination is asymmetric, the structure undergoes light-directed motion.

In FIG. 13a, the polymer microstructure 120 is standing up before exposure to light. In this case, polymer microstructures are prepared as described in FIG. 4c, these swellable trimethylolpropane trimethacrylate (TRIM) crosslinked poly(2-hydroxylethyl methacrylate) microstructures are aminiated with glycine and protected with the photolabile group 4-nitroveratryloxycarbanyl (NVOC) as described in FIGS. 8c and 8e. Addition of NVOC resulted in a volume increase >10% when performed in the solvent N,N′-dimethylformamide (DMF).

In FIG. 13b, the polymer microstructure 120 is bent over as a result of asymmetric exposure to light. Photochemical cleavage of NVOC is shown using asymmetric illumination as described in FIG. 4c of a microstructure 44 with a 365 nm laser induced polymer shrinkage in excess of 4% at the base of the cone and resulted in a maximum velocity of 1 mm/s at the tip of the cone, which demonstrates the use of a change in surface properties of the polymer microstructure to result in the directed movement of the polymer microstructure.

FIG. 14 illustrates the displacement of materials from polymer microstructure 120 as seen by the movement of particles away from the polymer microstructure. The movement of particles from microstructures as described in FIG. 13a-13b is away polymer upon symmetric illumination in the center of microstructure base with 365 nm light for 20 sec at 400 μW with 10× objective lens as described in FIG. 13b. The particle trajectories appear as dotted lines, as a result of changes in swelling due to sudden changes in surface properties. Light induces photochemical changes in the surface chemistry of porous polymer microstructures giving rise to a substantial change in volume. Photochemical cleavage of NVOC using illumination as described in FIG. 4c of microstructure 44 with a 365 nm laser induced polymer shrinkage in excess of 4% at the base of the microstructure gave rise to displacement of solvent from the microstructure due to shrinkage with a velocity in excess of 0.01 mm/s, which demonstrates the rapid release of materials from a polymer microstructure gel as a result of sudden change in surface properties.

There are numerous potential applications for arrays of microstructures to which a high density of reactive monomer or heteropolymer species have been attached. One example is to use patterned synthesis of different oligonucleotides on the array elements and hybridize labeled DNA or RNA to this array, resulting in a very sensitive version of a “DNA chip”. This would allow one to detect expression at lower levels than is possible with chips that utilize monolayers of DNA or to use much less expensive equipment to read the array.

The concept could be further generalized by making arrays of DNA, RNA, peptide or other heteropolymer in high density on microstructures in a patterned fashion such that these arrays contain a selection of heteropolymers in known positions that bind specific target molecules or classes of target molecules that can be used in diagnostic tests. Because of the high density of heteropolymers on the arrays, the diagnostic detection limits will be much more sensitive, and/or the equipment required to read the array will be simpler and cheaper.

Another example again involves making an array of DNA oligonucleotides but to specifically make a set of oligonucleotides that upon release from the microstructures and hybridization (self assembly) followed by extension, ligation and polymerase chain reaction (methods well known in the art) could be used to rapidly synthesize large pieces of double stranded or single stranded DNA.

Another example involves making an array of DNA, RNA, peptide or other heteropolymer in high density on microstructures in a patterned fashion in such a way that each of the elements (or each group of elements) in the array have a different heteropolymer structure attached. The array could be used as a library in a molecular evolution approach in which the individual array elements are assayed for some function (for example, binding, catalytic activity, signal transduction), the best ones are selected, and the heteropolymers selected from the first round of screening for activity are used, potentially along with computer modeling, to generate a new library. The library could be made as before and screened and the process continued until the desired function is optimized.

While one or more embodiments of the present invention have been illustrated in detail, the skilled artisan will appreciate that modifications and adaptations to those embodiments may be made without departing from the scope of the present invention as set forth in the following claims.

What is claimed is:

1. An array of chemically reactive sites, comprising:
a substrate; and
a plurality of three-dimensional microstructures formed on the substrate, each three-dimensional microstructure being made with polymer material and having a plurality of reactive sites formed on a surface of the three-dimensional microstructure.

2. The array of claim 1, wherein the three-dimensional microstructure increases surface area and density of the reactive sites on the surface of the three-dimensional microstructure.

3. The array of claim 1, wherein one type of polymer material is polymer gel.

4. The array of claim 1, wherein the polymer material is porous on a portion of the surface of the three-dimensional microstructure.

5. The array of claim 1, further including a plurality of chemical groups respectively attached to ones of the reactive sites on the surface of the three-dimensional microstructure, each chemical group including at least one monomer.

6. The array of claim 5, wherein a first one of the plurality of chemical groups has a first chemical structure and a second one of the plurality of chemical groups has a second chemical structure.

7. The array of claim 1, wherein a microchannel is formed around at least one of the plurality of three-dimensional microstructures.

8. An array of chemically reactive sites, comprising:
a substrate; and
a plurality of microstructures formed on the substrate, each microstructure being made with porous polymer material and having a plurality of reactive sites formed on a surface of the microstructure.

9. The array of claim 8, wherein the plurality of microstructures are three-dimensional in form.

10. The array of claim 8, wherein the porous polymer material increases surface area of the microstructure and density for the reactive sites on the surface of the microstructure.

11. The array of claim 8, wherein one type of porous polymer material is porous polymer gel.

12. The array of claim 8, further including a plurality of chemical groups respectively attached to ones of the reactive sites on the surface of the microstructure, each chemical group including at least one monomer.

13. The array of claim 12, wherein a first one of the plurality of chemical groups has a first chemical structure and a second one of the plurality of chemical groups has a second chemical structure.

14. A method of making an array of chemically reactive sites, comprising:
providing a substrate; and
disposing a plurality of three-dimensional microstructures on the substrate, each three-dimensional microstructure being made with polymer material and having plurality of reactive sites formed on a surface of the three-dimensional microstructure.

15. The method of claim 14, wherein the three-dimensional microstructure increases surface area and density of the plurality of reactive sites on the surface of the three-dimensional microstructure.

16. The method of claim 14, wherein one type of polymer material is polymer gel.

17. The method of claim 14, wherein the polymer material is porous on a portion of the surface of the three-dimensional microstructure.

18. The method of claim 14, further including attaching a plurality of chemical groups to ones of the reactive sites on the surface of the three-dimensional microstructure, each chemical group including at least one monomer.

19. The method of claim 18, further including:
forming a first one of the plurality of chemical groups with a first chemical structure; and
forming a second one of the plurality of chemical groups with a second chemical structure.

20. The method of claim 14, further including forming a microchannel around at least one of the plurality of three-dimensional microstructures.

21. In an array of chemically reactive sites, a plurality of polymer microstructures formed on a surface of the array, each microstructure comprising:
a plurality of reactive sites disposed on a plurality of surfaces of each polymer microstructure, each reactive site having a reactant molecule with at least one monomer.

22. The array of claim 21, wherein the plurality of polymer microstructures are three-dimensional in form.

23. The array of claim 22, wherein the three-dimensional form of the polymer microstructure increases surface area and density of the reactive sites on the plurality of surfaces of each polymer microstructure.

24. The array of claim 21, wherein ones of the plurality of polymer microstructures are made with polymer gel.

25. The array of claim 24, wherein a portion of the surface of the polymer microstructure is porous.

26. The array of claim 21, further including a plurality of chemical groups respectively attached to ones of the reactive sites on the plurality of surfaces of each polymer microstructure, each chemical group including at least one monomer.

27. The array of claim 26, wherein a first one of the plurality of chemical groups has a first chemical structure and a second one of the plurality of chemical groups has a second chemical structure.

28. The array of claim 21, wherein a microchannel is formed around at least one of the plurality of polymer microstructures.

29. An array of chemically reactive sites, comprising:
a substrate; and
a plurality of three-dimensional microstructures formed on the substrate, each three-dimensional microstructure being made with a material and having a plurality of reactive sites formed on a surface of the three-dimensional microstructure.
